(19) United States
(12) Patent Application Publication
(10) Pub. No.: US 2007/0244747 A1
(43) Pub. Date: Oct. 18, 2007

(54) Method and system for recommending products to consumers by induction of decision trees

(76) Inventor: Daniel N. Nikovski, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/404,940

(22) Filed: Apr. 14, 2006

(51) Int. Cl. G06Q 30/00

(52) U.S. Cl. 705/14

(57) ABSTRACT

A method and system recommend a product to a consumer. A purchasing history of a consumer is represented by an adjacency lattice stored in a memory. Training examples are extracted from the adjacency lattice, and a decision tree is constructed using the training examples. A size of the decision tree is reduced, and the reduced size decision tree is searched for a recommendation of a product to the consumer.

### FIELD OF THE INVENTION

This invention relates generally to systems and methods for recommending products to consumers, and more particularly to personalized recommendation systems based on frequent item-set discovery.

### BACKGROUND OF THE INVENTION

Personalized recommendation systems decide which product to recommend to a consumer based on a purchasing history recorded by a vendor. Typically, the recommendation method tries to maximize the likelihood that the consumer will purchase the product, and perhaps, to maximize the profit to the vendor.

This capability has been made possible by the wide availability of purchasing histories and advancement of computationally-intensive statistical data mining techniques. Nowadays, personal recommendation is a major feature of online ‘e-commerce’ web sites. Personal recommendation has a significant part in direct marketing, where it is used to decide which consumers receive which catalogs, and the products included in the catalogs.

Recommendation as Response Modeling

Usually, the recommendation method estimates a probability Pr(Aᵢ=True|H) that a given product Aᵢ from a set of the products [symbol] of a vendor will be purchased based on a purchasing history H, where H⊂ [symbol] .

It is assumed that past purchases correlate well with future purchases, and information about consumer preferences can be extracted from the purchasing history of the consumer. In the usual case, all evidence is positive. If a purchase of a product Aⱼ has not been recorded by a particular vendor, it is assumed that Aⱼ=False, even though the consumer might have purchased this product from another vendor. This task is also known as response modeling because the task seeks to model quantitatively a likelihood that the consumer will purchase the recommended product, B. Ratner, “Statistical Modeling and Analysis for Database Marketing,” Boca Raton: Chapman and Hall, CRC, 2003.

After the probabilities for purchasing each available product have been estimated, an optimal product to recommend can be determined in several ways according to a recommendation policy. The simplest recommendation policy recommends the product A* with a highest probability of purchase:
A*=argmax_{A}_{ᵢ}_{=True}Pr(Aᵢ|H).

For this recommendation to be truly optimal, three conditions must hold. First, the profit from each product must be the same. Second, the consumer must make only one product choice, or future purchases must be independent of that choice. Third, the probability of purchasing each product, if it is not recommended, must be constant. In practice, these three conditions almost never hold, which gives rise to several more realistic definitions of optimal recommendations.

Varying profits r(Aᵢ) among products can be accounted for by a policy that recommends the product A* with a maximum expected profit:
A*=argmax_{A}_{ᵢ}Pr(Aᵢ=True|H)r(Aᵢ).

When the probability of purchasing a product not recommended varies, it is more useful to have a policy that recommends the product for which the increase in probability due to recommendation is the greatest. This requires separate estimation of consumer response for the case when a product was recommended and the alternative case when the product is not recommended. Departures from the third condition can be dealt with by solving a sequential Markov decision process (MDP) model that optimizes the cumulative profit resulting from a recommendation rather than the immediate profit. This scenario also reduces to response modeling because profits from individual products and transition probabilities are all that is required to specify the MDP.

Estimation of Response Probabilities

It is always possible to infer Pr(Aᵢ=True|H) for any Aᵢ and H if the joint probability function (JPF) over all Boolean variables Aᵢ, i=1, N, N=| [symbol] | are known:
Pr(Aᵢ=True|H)=(Pr(Aᵢ∪H))/Pr(H),
where Pr(Aᵢ∪H) and Pr(H) can be obtained from the JPF.

In practice, the JPF is not known a priori. Instead, the JPF is determined by a suitable computational method. When the purchase history is used for the estimation of the JPF, this reduces to the problem of density estimation, and is amenable to analysis by known data mining processes.

In the field of personalized recommendation, this approach is also known as collaborative filtering because it leverages the recorded preferences and purchasing patterns of an existing group of consumers to make recommendations to that same group of consumers.

However, from a perspective of data mining and statistical machine learning, direct estimation of each and every entry of the JPF of a product domain is usually infeasible for at least two reasons. First, there are exponentially many such entries, and the memory requirements for their representation grow exponentially with the size of the product assortment [symbol] . Second, even if it were somehow possible to represent all entries of the JPF in a memory, their values could not be estimated reliably by means of frequency counting from the purchasing history unless the size of the history also grows exponentially in [symbol] . However, the size of the purchasing history is usually linear according to the time period a vendor has been in business rather than exponential in the size of the product assortment. The usual method to deal with this problem is to impose some structure on the JPF.

One solution involves logistic regression, which has been called “the workhorse of response modeling.” The problem with logistic regression is that it fails to model the interactions among variables in the purchasing history H, and considers individual product influences independently.

A significant improvement can be realized by the use of more advanced data mining techniques such as neural networks, support-vector machines, or any other machine learning method for building classifiers. Although this has practical impact on recommended products, in particular the induction of dependency networks, it depends critically on progress in induction of classifiers on large databases, which is by no means a readily-solved problem.

### SUMMARY OF THE INVENTION

Embodiments of the invention provide a method for induction of compact optimal recommendation policies based on discovery of frequent item-sets in a purchasing history. Decision-tree learning processes can then be used for the purposes of simplification and compaction of the recommendation policies stored in a memory.

A structure of such policies can be exploited to partition the space of consumer purchasing histories much more efficiently than conventional frequent item-set discovery processes alone allow.

The invention uses a method that is based on discovery of frequent item-set (FI) lattices, and subsequent extraction of direct compact recommendation policies expressed as decision trees. Processes for induction of decision trees are leveraged to simplify considerably the optimal recommendation policies discovered by means of frequent item-set mining.

### BRIEF DESCRIPTION OF THE DRAWINGS

FIG. 1 is a flow diagram of a method for recommending products to consumers according to an embodiment of the invention;

FIG. 2 is a directed acyclic graph representing an adjacency lattice for all possible item-sets in a purchasing history;

FIG. 3 is a prefix tree representing an adjacency lattice;

FIG. 4 is an example adjacency lattice;

FIG. 5 is an example decision tree;

FIG. 6 is a compact decision tree corresponding to the tree of FIG. 5; and

FIG. 7 is a graph comparing the number of nodes in a prefix tree and a decision.

### DETAILED DESCRIPTION OF THE PREFERRED EMBODIMENTS

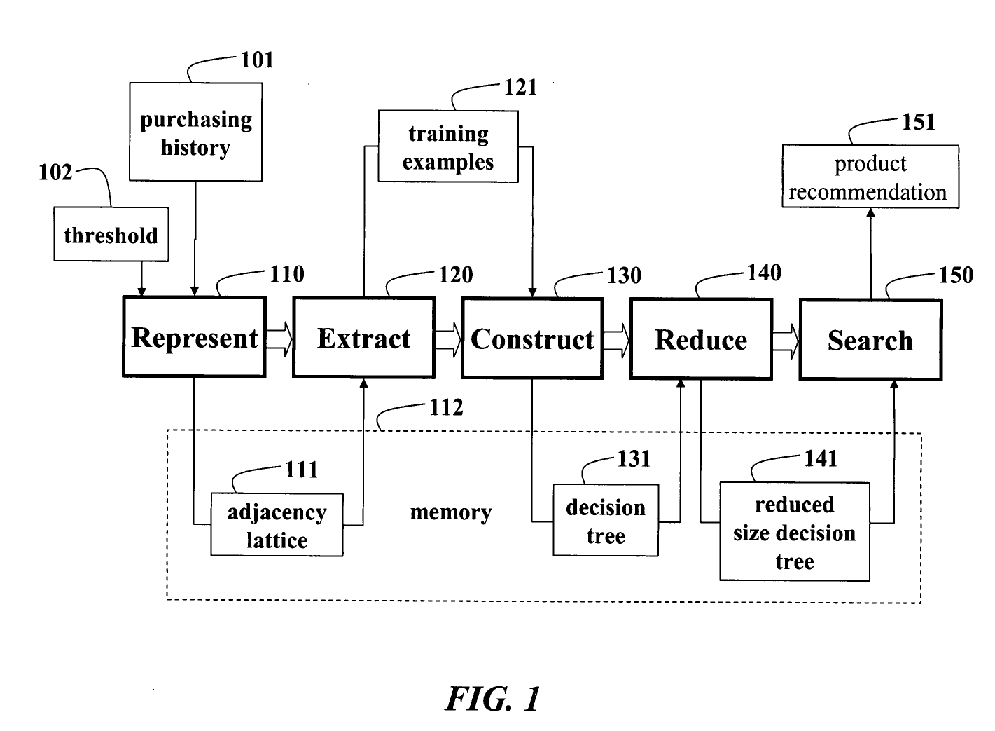

FIG. 1 shows a method for recommending products to consumers according to an embodiment of our invention. A purchasing history 101 is represented 110 as an adjacency lattice 111 stored in a memory 112 using a predetermined threshold 102. The adjacency lattice 111 is used to extract 120 training samples 121 of the optimal recommendation policy. The training samples are used to construct 130 a decision tree 131. We reduce 140 a size of the decision tree 131 to a reduced size decision tree 141. The reduced size tree 141 can then be searched 150 to make a product recommendation 151.

Frequent Item Discovery

A set of items available from a vendor is T={A, B, C, D}. A purchasing history 101 includes transactions T. Each transaction is an item pair including an identification and an item-set, (ID, item-set), see Table A.

TABLE A

| Database ID | Item-set |
|---|---|
| 100 | {A, B, D} |
| 200 | {A, B} |
| 300 | {C, D} |
| 400 | {B, C} |

A support, supp(X), of an item-set X⊂T is the number of purchases Y in the transaction history T such that X⊂Y. An item-set X⊂T is frequent if its support is greater than or equal to a predefined threshold θ102. Table B shows all frequent item-sets in T with a threshold θ=1.

TABLE B

| Itemset | Cover ID | Support |
|---|---|---|
| { } | {100, 200, 300, 400} | 4 |
| {A} | {100, 200} | 2 |
| {B} | {100, 200, 300} | 3 |
| {C} | {300, 400} | 2 |
| {D} | {100, 300} | 2 |
| {A, B} | {100, 200} | 2 |
| {A, D} | {100} | 1 |
| {B, C} | {400} | 1 |
| {B, D} | {100} | 1 |
| {C, D} | {300} | 1 |
| {A, B, D} | {100} | 1 |

Adjacency Lattice

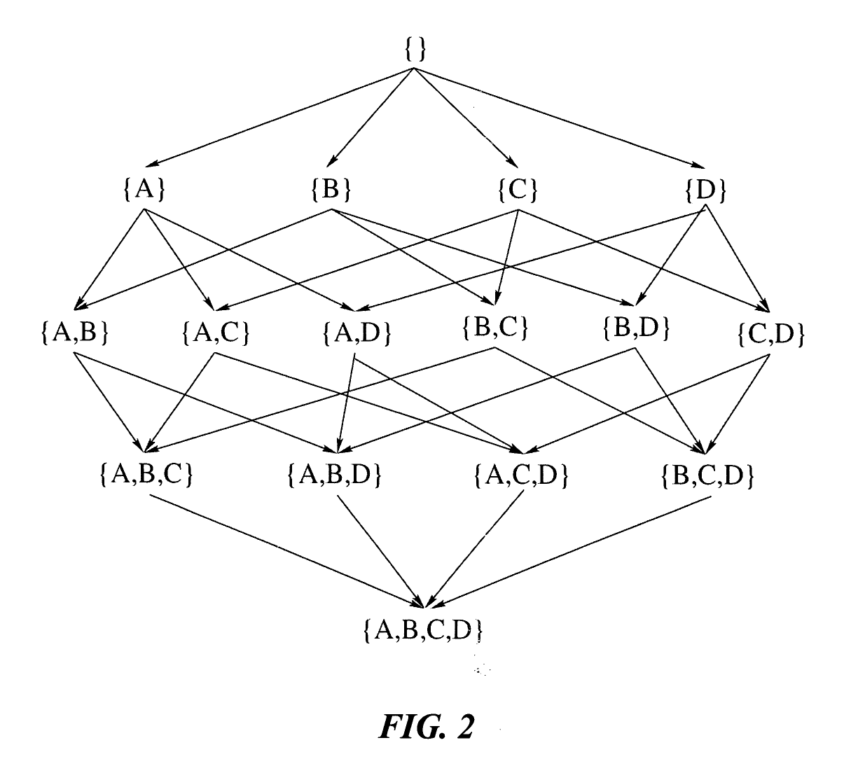

Before we describe how item-sets can be used for personalized recommendation, we describe the adjacency lattice 111 of item-sets. As shown in FIG. 2, we use a directed acyclic graph to represent the adjacency lattice 111 for all possible item-sets in T. A set of items X is adjacent to another set of items Y if and only if Y can be obtained from X by adding a single item. We designate a parent by X and a child by Y.

The adjacency lattice 111 is one way of organizing all subsets of available items, which differs from other alternative methods, such as N-way contingency tables, for example, in its progression from small subsets to large subsets. In particular, all subsets at the same level of the lattice have the same cardinality. If we want to represent the full JPF of a problem domain, then we can use the adjacency lattice to represent the probabilities of each subset.

However, we can reduce memory requirements if we store only those subsets whose probabilities are above the threshold 102. Such subsets of items are called frequent item-sets, and an active sub-field of data mining is concerned with efficient process frequent item-set mining (FIM).

Given the threshold 102, these processes locate item-sets whose support exceeds the threshold, and record for each item the exact number of transactions that support the item. Note that this representation is not lossless. By storing only frequent item-sets and discarding less frequent items, we are trading the accuracy of the JPF for memory size.

The Apriori process can generate the adjacency lattice 111 for a given transaction database (purchasing history 101) T, and threshold θ102, R. Agrawal, T. Imielinski, and A. Swami, “Mining association rules between sets of items in very large databases,” Proc. of the ACM SIGMOD Conference on Management of Data, pp. 207-216, May 1993, incorporated herein by reference.

First, the process generates all frequent item-sets X where |X|=1. Then, all frequent item-sets Y are generated, where |Y|=2, and so on. After every item-set generation, the process deletes item-sets with supports lower than the threshold θ. The threshold 102 is selected so that all frequent item-sets can fit in the memory. Note that while the full JPF of a problem domain can typically not fit in memory, we can always make the frequent item-set (FI) adjacency lattice 111 fit in the available memory by raising the support threshold. Certainly, the lower the threshold, the more complete the JPF.

After the sparse FI lattice has been generated, the lattice can be used to define the recommendation policy much like a full JPF could be used, with some provisions for handling missing entries. The easiest case is when the item-set H corresponding to the purchasing history of a consumer is represented in the lattice, and at least one of its descendants Q in the lattice is also present. Then, the optimal recommendation is an extension A=Q\H of the set H that maximizes the support of the direct descendants Q of H in the lattice. By definition, the descendant frequent items of H in the adjacency lattice differ from H by only one element, which facilitates the search for optimal recommendations. Note that only the existing descendant FIs are examined in order to find the optimal recommendation. If all other possible descendants are not frequent, then their support is below that of the frequent item-sets and the extensions leading to them cannot be optimal.

A more complicated case occurs when the complete purchasing history H is not a FI set. There are several ways to deal with this case. These are not as important as the main case described above, because these happen infrequently. Still, one reasonable approach is to find the largest subset of H that is frequent and has at least one frequent descendant, and use the optimal recommendation for that largest subset.

In practice, the process finds the largest frequent subset present in the lattice, and uses the optimal recommendation for its parent. In the case when several largest subsets of the same cardinality exist, ties can be broken randomly, or more sophisticated processes for accommodating several local models into one global can be used, H. Mannila, D. Pavlov, and P. Smyth, “Predictions with local patterns using cross-entropy,” Proc. of Fifth ACM SIGKDD International Conference on Knowledge Discovery and Data Mining, pp. 357-361, ACM Press, 1999, incorporated herein by reference.

The definition of the optimal recommendation is performed only one time. The recommendation can be stored in the lattice, together with the support of that set. Table C shows the recommendations extracted from the lattice for every item-set with a minimum support threshold of 1.

TABLE C

| Itemset | | Recommendation | Purchase Prob. |
|---|---|---|---|
| { } | [symbol] | {B} | 0.75 |
| {A} | [symbol] | {B} | 1.00 |
| {B} | [symbol] | {A} | 0.66 |
| {C} | [symbol] | {B} or {D} | 0.50 |
| {D} | [symbol] | {A} or {C} | 0.50 |
| {A, B} | [symbol] | {D} | 0.50 |
| {A, D} | [symbol] | {B} | 1.00 |
| {B, C} | [symbol] | { } | 1.00 |
| {B, D} | [symbol] | {A} | 1.00 |
| {C, D} | [symbol] | { } | 1.00 |
| {A, B, D} | [symbol] | { } | 1.00 |

We call the mapping from past purchases to optimal products to be recommended a recommendation policy. This definition of optimality corresponds to the simplest objective of product recommendation, namely maximizing the probability that the recommended product is purchased. However, any number of more elaborate formulations of optimality described above can also be used to define the recommendation policy, although these can result in different recommendation policies that are, nevertheless, of the same form: a mapping from purchasing histories to products to be recommended.

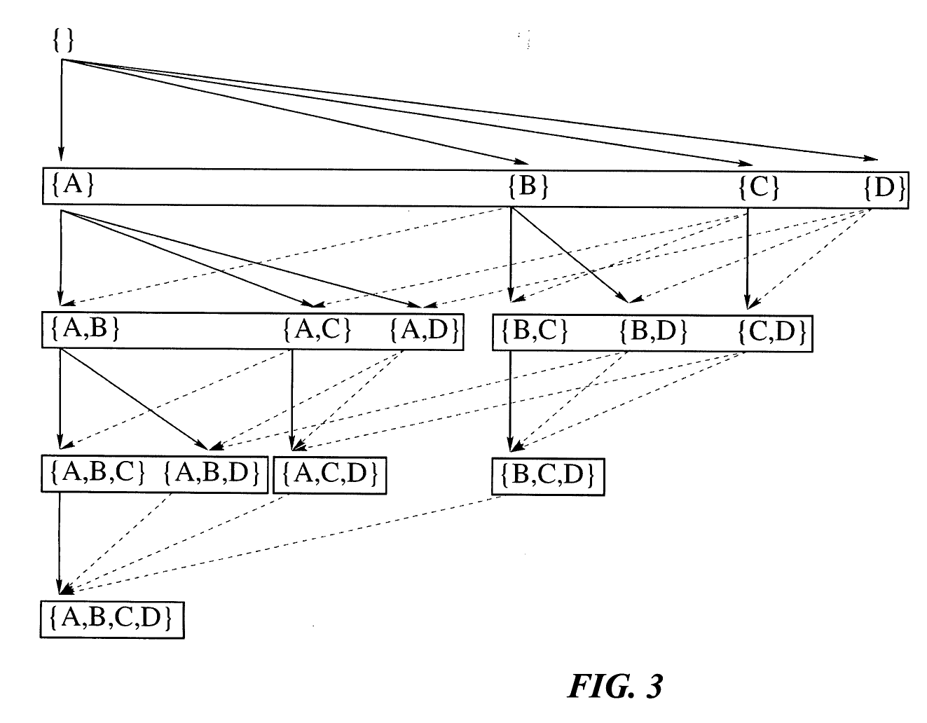

As shown in FIG. 3, the adjacency lattice is usually stored as a prefix tree that does not represent all the lattice edges explicitly, B. Goethals, “Efficient Frequent Pattern Mining,” PhD Thesis, Transnational University of Limburg, Diepenbeek, Belgium, December 2002. As shown in FIG. 3, the missing edges are indicated by dashed lines.

For example, the set {A, B, C} is a parent to the set {A, B, C, D}, but the set {B, C, D} is not a parent to the set {A, B, C, D}. The set {A, B, C, D} is called an indirect child to the set {B, C, D}. Searching for indirect children, however, is not a major problem. In practice, the process generates, in turn, all possible extensions, uses the prefix tree to locate the corresponding item-set, and considers the item-set to define the optimal recommendation policy when the item-set is frequent.

Before discussing our idea for representation and compaction of the recommendation policy by means of decision trees, we compare our method with personalized recommendation based on association rules, W. Lin, S. A. Alvarez, and C. Ruiz, “Efficient adaptive-support association rule mining for recommender systems,” Data Mining and Knowledge Discovery, vol. 6, no. 1, pp. 83-105, 2002; and B. Mobasher, H. Dai, T. Luo, M. and Nakagawa, “Effective personalization based on association rule discovery from web usage data,” Proc. of the Third International Workshop on Web information and Data Management, ACM Press, New York, pp. 9-15, 2001.

They describe association rules of a form “If H, then y with probability P,” match the antecedents of all rules to a purchasing history, and use the most specific rule to estimate the probabilities of product purchases, or, for the last step, use some other arbitration mechanism to resolve conflicting rules.

However, our objective is not to improve on the accuracy of these processes in estimating the consumer response probabilities, nor to compare the accuracy of FI-based recommenders with that of alternative methods based on logistic regression, e.g., neural nets. Instead, an objective consistent with our invention is to reduce time and memory required to store and produce optimal recommendations derived by means of discovery of frequent item-sets.

The motivation for this objective is the observation that these processes are inefficient in matching purchasing histories to rules because the rules have to be searched sequentially unless additional data structures are used. It is not likely that they would be any simpler than a prefix tree.

In contrast, a search in an adjacency matrix represented by a prefix tree is logarithmic in the number of item-sets represented in the prefix tree. Furthermore, general processes for induction of association rules generate far too many rules to be processed in a practical application. While there are 2^{N} item-sets in a domain, there are 3^{N} possible association rules, which makes a big difference in memory requirements.

However, a recommendation policy stored in the lattice also has disadvantages. First, it is not very portable. Unlike sets of association rules, which can be stored and exchanged using a predictive model markup language (PMML), there is no convenient PMML representation of a prefix tree or adjacency lattice. Second, and even more important, the lattice encodes a sparse JPF, while we only need the recommendation policy.

A large discrepancy can exist between the complexity of a JPF and the complexity of the optimal recommendation policy implied by that JPF. As an example, consider a domain of N products whose purchases are completely uncorrelated. Still, not knowing this, the JPF has on the order of 2^{N} entries. Representing only frequent item-sets reduces the memory required for their representation. However, if their individual purchase frequencies are similar, then this does not help much.

The optimal recommendation policy, because past purchasing history has no correlation to future purchases, is to recommend the most popular item not already owned by the consumer, i.e, if the consumer has not purchased the most popular item, then recommend it, otherwise if the consumer has not purchased the second most popular item, then recommend it instead, and so on until the least popular item is recommended to a consumer who already has purchased everything else. Clearly, such a recommendation policy is only linear in N, while the JPF of the problem domain is exponential in N.

While this is an extreme constructed example, and inter-item correlations certainly do exist in real purchasing domains otherwise the whole idea of personalized recommendation is futile, our hypothesis is that this discrepancy between the complexity of the JPF and that of the recommendation policy still exists in real domains to a large extent.

Construction of Decision Trees from Adjacency Lattices

Decision trees are frequently used for data mining, classification and regression. A decision tree can include a root node, intermediate nodes where attributes, i.e. variables, are tested, and leaf nodes where purchasing decisions are stored.

Because a recommendation policy is a mapping between the purchasing history (inputs) and optimal product recommendations (output), a decision tree is a viable structure for representing a recommendation policy.

When we want to represent a recommendation policy as a decision tree, one approach is to convert directly the prefix tree of the adjacency lattice to a decision tree. Each node of the prefix tree that has n descendants is represented as n binary nodes. The nodes can be tested in sequence to determine whether the consumer has purchased each of the corresponding n items that label the edges leading to the descendant nodes.

If this approach is followed, the resulting decision tree is much larger than the original lattice. Instead, our approach is to treat the problem of encoding the recommendation policy as a machine learning problem. Our expectation is that the optimal partitioning of the item-set space for the purpose of representing the recommendation policy is very different from the optimal partitioning of that space for the purpose of storing the JPF of purchasing patterns, and that existing processes for induction of decision trees would be able to discover the former partitioning.

In order to use these processes for induction of decision trees, we extract 120 the training examples 121. We have one example for each item-set in the lattice. Each frequent item-set is represented as a complete set of Boolean variables, which are used as input variables. The optimal product to be recommended is given as the class label of the output.

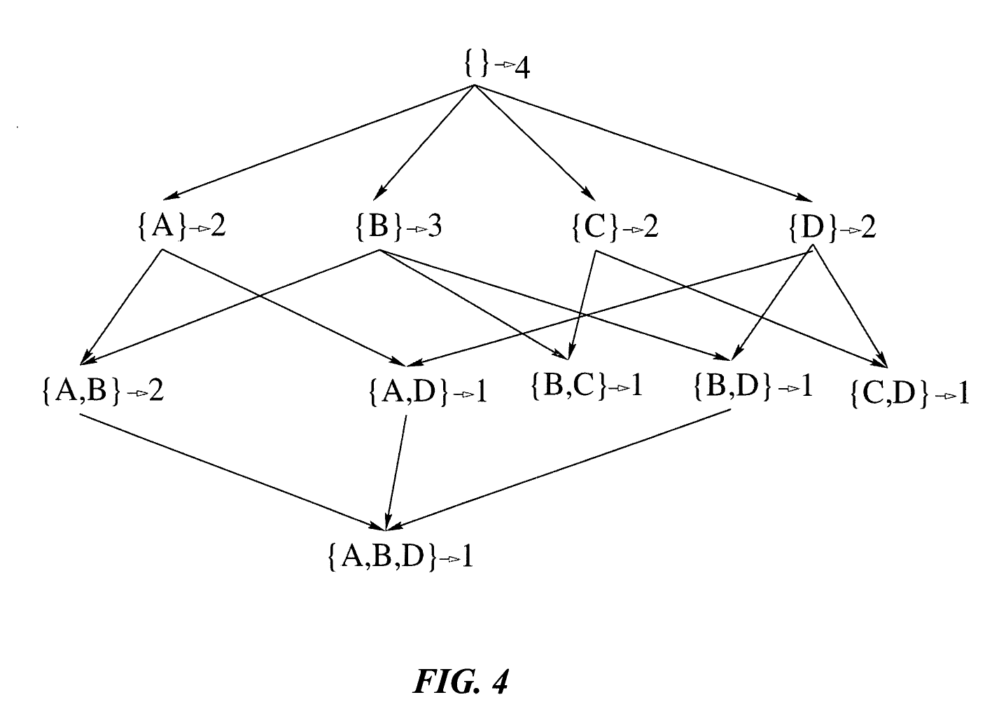

Table D shows an example data transformation, and FIG. 4 shows the corresponding adjacency lattice.

TABLE D

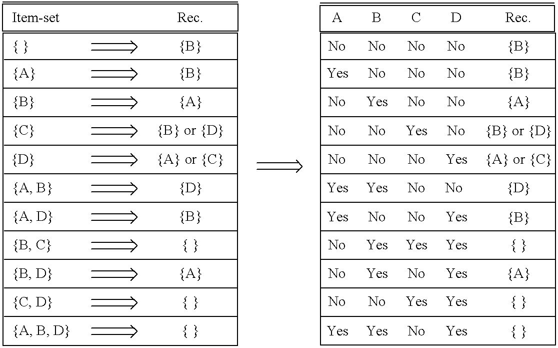

We use this list of item-sets and recommendations as the training examples 121 for constructing the decision tree 131.

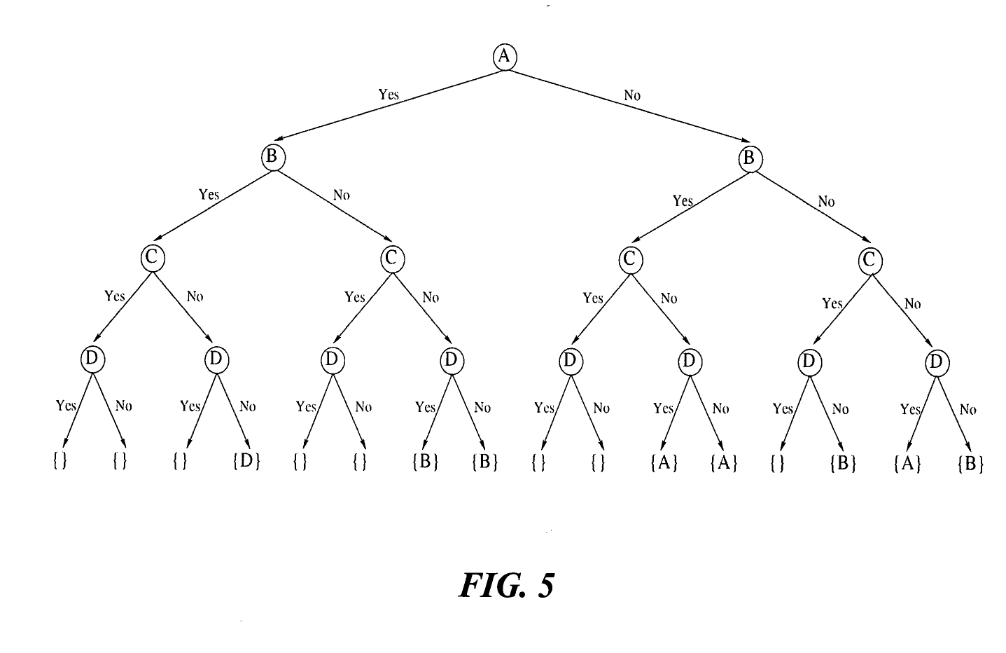

There are many possible decision trees that can classify correctly a given set of training examples. Some are larger than others. For example, if we are given the examples in Table D, a possible decision tree is shown in FIG. 5. However, this tree is rather large.

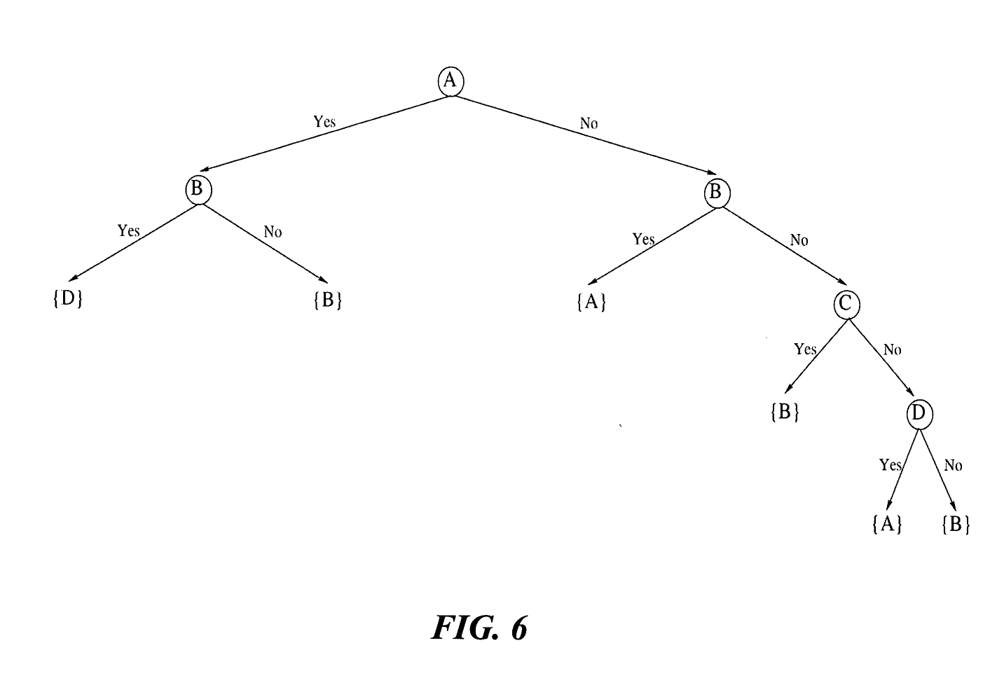

FIG. 6 shows a decision tree that is just as good, and significantly smaller. While finding the most compact decision tree is not a trivial problem, our approach is to use greedy processes such as ID3 and C4.5, J. R. Quinlan, “Induction of decision trees,” Machine Learning, vol. 1, no. 1, pp. 81-106, 1986; and J. R. Quinlan, “C4.5: Programs for Machine Learning” San Mateo: Morgan Kaugmann, 1993, incorporated herein by reference. These procedures can produce very compact decision trees with excellent classification properties.

After we extract training examples as described above, we rely on these general processes for induction of decision trees to reduce 140 the size of the new decision tree 131. Comparison results described below showed that on larger purchasing histories, our method performs better in terms of number of nodes, and generates simpler data structures represented with decision trees compared to the lattice representation for the same data.

The reduced size decision tree 141 can now be searched 150 to find the recommendation.

Application

We apply our method to a well known retail data set frequently used for evaluating frequent item-set mining, T. Brijs, G. Swinnen, K. Vanhoof, and G. Wets, “The use of association rules for product assortment decisions: a case study,” Proc. of the Fifth International Conference on KDD, pp. 254-260, August 1999, incorporated herein by reference. The data set includes 41,373 records. In this evaluation, we used the implementation of Apriori of Goethals, above. After generating training examples, decision trees are generated. During decision tree induction, split attributes are selected using a mutual information (entropy) criterion. In all cases, completely homogeneous trees are generated. This is always possible, because each training example has unique input.

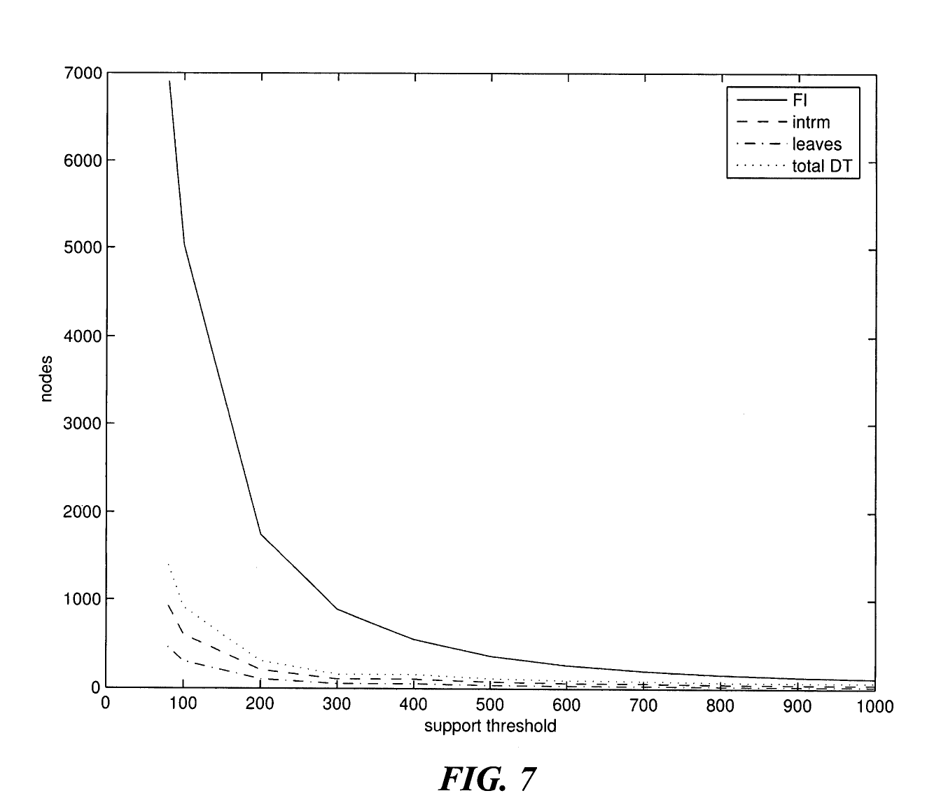

FIG. 7 shows a comparison between the number of nodes in the prefix tree (FI) and that of the nodes and leaves of the decision tree (DT), both plotted against the support threshold. For the case of decision trees, the nodes are broken down into intermediate (decision) nodes, denoted by ‘intrm,’ and recommendations denoted by ‘leaves.’ It should be noted that the leaf nodes can record recommendations.

FIG. 7 shows that decision trees indeed result in more compact recommendation policies. Furthermore, the percentage savings are not constant. The savings increase with the size of the policy. In some cases, the decision tree construction process is able to reduce the number of nodes necessary to encode the policy by up to 80%. This shows that there is indeed significant structure in the discovered recommendation policy, and the learning process was able to discover it.

Moreover, storing a binary decision tree is much better than storing a prefix tree with the same number of nodes because, in general, the prefix tree is not binary. Furthermore, a decision tree can be converted to the PMML format. The induced tree handles new consumers directly, even those whose full purchasing histories are not represented explicitly in the adjacency lattice.

### EFFECT OF THE INVENTION

Described is a frequent item-set discovery processes for personalized product recommendation. A method compresses a recommendation policy by means of decision tree induction processes. Because the adjacency matrix of all frequent item-sets consumes a lot of memory and results in relatively long look-up times, we compress the recommendation policy by means of a decision tree. To this end, a process for ‘learning’ decision trees is applied to training samples. We discovered that decision trees indeed resulted in more compact recommendation policies.

Our method can also be applied to more sophisticated recommendation policies, for example, ones based on extraction of frequent sequences. Such policies model the sequential nature of consumer choice significantly better than temporal associations because the discovery of frequent sequences is not much more difficult than the discovery of frequent item-sets. It is expected that the adjacency lattice of frequent sequences can be compressed similarly to that of frequent item-sets. Therefore, our approach can be generalized to sequential recommendation policies.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. A computer implemented method for recommending a product to a consumer, comprising the steps of:
representing a purchasing history of a consumer as an adjacency lattice;
extracting training examples from the adjacency lattice;
constructing a decision tree using the training examples:
reducing a size of the decision tree to a reduced size decision tree; and
searching the reduced size decision tree for a recommendation of a product to the consumer.

2. The method of claim 1, in which the extracting is according to a predetermined threshold.

3. The method of claim 1, in which the purchasing history includes items, each item having an identification and an item-set.

4. The method of claim 1, in which the adjacency lattice is in a form of a directed acyclic graph.

5. The method of claim 1, in which the decision tree includes a root node, intermediate nodes for storing attributes, and leaf nodes for storing purchasing decisions.

6. The method of claim 1, in which the constructing uses machine learning processes.

7. The method of claim 1, in which the decision tree is a binary tree.

8. A system for recommending a product to a consumer, comprising the steps of:
a memory configured to store an adjacency lattice representing a purchasing history of a consumer;
means for extracting training examples from the adjacency lattice;
means for constructing a decision tree using the training examples;
means for reducing a size of the decision tree to a reduced size decision tree; and
means for searching the reduced size decision tree for a recommendation of a product to the consumer.

9. The system of claim 8, in which the purchasing history includes items, each item having an identification and an item-set.
